(19) United States
(12) Patent Application Publication
(10) Pub. No.: US 2026/0228933 A1
(43) Pub. Date: Aug. 6, 2026

(54) ELECTRONIC DEVICE AND METHOD OF SCENE RENDERING

(71) Applicant: Samsung Electronics Co., Ltd., Suwon-si (KR)

(72) Inventors: Jinwoo PARK, Suwon-si (KR); Nahyup Kang, Suwon-si (KR); Jiyeon Kim, Suwon-si (KR)

(73) Assignee: Samsung Electronics Co., Ltd., Suwon-si (KR)

(21) Appl. No.: 19/256,795

(22) Filed: Jul. 1, 2025

(30) Foreign Application Priority Data
Feb. 6, 2025 (KR) 10-2025-0015441

(51) Int. Cl. G06T 11/00; G06N 3/045; G06N 3/0499; G06T 15/50

(52) U.S. Cl. CPC G06T 11/00; G06N 3/045; G06N 3/0499; G06T 15/506

(57) ABSTRACT

An electronic device, including: at least one processor; and a memory storing instructions, wherein the instructions, when executed by the at least one processor, cause the electronic device to: select a three-dimensional (3D) point included in a scene corresponding to a viewpoint, using a first machine learning-based model, obtain a first partial bidirectional scattering distribution function (BSDF) value based on a view direction toward the 3D point from the viewpoint, a ray direction sampled at the 3D point, and material information, obtain a second partial BSDF value using a second machine learning-based model, wherein the second machine learning-based model is connected to the first machine learning-based model, determine a full BSDF value for the ray direction at the 3D point based on the first partial BSDF value and the second partial BSDF value, and generate an image corresponding to the scene by determining a value of a pixel corresponding to the view direction based on the sampled ray direction, the full BSDF value, and a probability density function (PDF) value.

### CROSS-REFERENCE TO RELATED APPLICATION

This application is based on and claims priority under 35 U.S.C. § 119 to Korean Patent Application No. 10-2025-0015441, filed on Feb. 6, 2025, in the Korean Intellectual Property Office, the disclosure of which is incorporated by reference herein in its entirety.

### BACKGROUND

### 1. Field

The disclosure relates to scene rendering.

### 2. Description of the Related Art

A realistic synthesis of images and video is an important goal of computer graphics. A method and representation for mimicking an image formation model of a real camera including complex materials and global lighting processing have been developed. The method is based on the laws of physics and simulates transmission of light from a light source to a virtual camera for synthesis. To achieve this, all physical parameters of a scene need to be determined in a rendering process. For example, the parameters include information on the scene geometry and material properties such as reflectivity or opacity. When the information is provided, a latest ray tracking technique generates a realistic image. Various methods, which are close to a real image formation model and are based on mathematical approximation, are available other than the physics-based rendering method.

### SUMMARY

One or more embodiments may address at least the above problems and/or disadvantages and other disadvantages not described above. Also, the embodiments are not required to overcome the disadvantages described above, and an embodiment may not overcome any of the problems described above.

In accordance with an aspect of the disclosure, an electronic device includes: at least one processor; and a memory storing instructions, wherein the instructions, when executed by the at least one processor, cause the electronic device to: select a three-dimensional (3D) point included in a scene corresponding to a viewpoint, using a first machine learning-based model, obtain a first partial bidirectional scattering distribution function (BSDF) value based on a view direction toward the 3D point from the viewpoint, a ray direction sampled at the 3D point, and material information, obtain a second partial BSDF value using a second machine learning-based model, wherein the second machine learning-based model is connected to the first machine learning-based model, determine a full BSDF value for the ray direction at the 3D point based on the first partial BSDF value and the second partial BSDF value, and generate an image corresponding to the scene by determining a value of a pixel corresponding to the view direction based on the sampled ray direction, the full BSDF value, and a probability density function (PDF) value.

At least one of the first machine learning-based model and the second machine learning-based model may include a multi-layer perceptron (MLP) layer model.

The instructions, when executed by the at least one processor, may further cause the electronic device to determine the second partial BSDF value by propagating a value from an intermediate layer of the first machine learning-based model to the second machine learning-based model.

The first partial BSDF value may correspond to a first range and the second partial BSDF value may correspond to a second range, wherein the first range does not overlap the second range, and
wherein the second range is higher than the first range.

The instructions, when executed by the at least one processor, may further cause the electronic device to determine the full BSDF value by aggregating the first partial BSDF value and the second partial BSDF value.

The instructions, when executed by the at least one processor, may further cause the electronic device to sample the ray direction based on a plurality of lobes corresponding to at least one of a potential reflection and a transmission at the 3D point.

The instructions, when executed by the at least one processor, may further cause the electronic device to estimate a spherical Gaussian (SG) parameter corresponding to each lobe from among the plurality of lobes using a third machine learning-based model.

The SG parameter may include at least one of an axis, a sharpness, and an amplitude of a corresponding lobe.

The instructions, when executed by the at least one processor, may further cause the electronic device to: determine a PDF corresponding to at least one of a reflection and a transmission of a ray at the 3D point based on a plurality of SG distributions in which the plurality of lobes is individually modeled, and sample the ray direction based on the determined PDF.

The instructions, when executed by the at least one processor, may further cause the electronic device to, based on determining that an object including a transparent material is included in the scene, generate a frame image corresponding to the scene within a threshold period of time by determining a corresponding pixel value using a BSDF value estimated based on a ray direction passing through the object.

In accordance with an aspect of the disclosure, a method, performed by a processor, of rendering a scene includes: selecting a three-dimensional (3D) point included in a scene corresponding to a viewpoint; using a first machine learning-based model, obtaining a first partial bidirectional scattering distribution function (BSDF) value based on a view direction toward the 3D point from the viewpoint, a ray direction sampled at the 3D point, and material information; obtaining a second partial BSDF value using a second machine learning-based model, wherein the second machine learning-based model is connected to the first machine learning-based model; determining a full BSDF value for the ray direction at the 3D point based on the first partial BSDF value and the second partial BSDF value; and generating an image corresponding to the scene by determining a value of a pixel corresponding to the view direction based on the sampled ray direction, the full BSDF value, and a probability density function (PDF) value.

At least one of the first machine learning-based model and the second machine learning-based model may include a multi-layer perceptron (MLP) layer model.

The obtaining of the second partial BSDF value may include determining the second partial BSDF value by propagating a value from an intermediate layer of the first machine learning-based model to the second machine learning-based model.

The first partial BSDF value may correspond to a first range and the second partial BSDF value may correspond to a second range, wherein the first range does not overlap the second range, and wherein the second range is higher than the first range.

The full BSDF value may be determined by aggregating the first partial BSDF value and the second partial BSDF value.

The method may further include: sampling the ray direction based on a plurality of lobes corresponding to at least one of potential reflection and transmission at the 3D point.

The sampling of the ray direction may include estimating a spherical Gaussian (SG) parameter corresponding to each lobe from among the plurality of lobes, using a third machine learning-based model.

The SG parameter may include at least one of an axis, a sharpness, and an amplitude of a corresponding lobe.

The sampling of the ray direction may include: determining a PDF corresponding to at least one of a reflection and a transmission of a ray at the 3D point based on a plurality of SG distributions in which the plurality of lobes is individually modeled; and sampling the ray direction based on the determined PDF.

The generating of the image corresponding to the scene may include, based on determining that an object including a transparent material is included in the scene, generating a frame image corresponding to the scene within a threshold period of time by determining a corresponding pixel value using a BSDF value estimated based on a ray direction passing through the object.

Additional aspects of embodiments will be set forth in part in the description which follows and, in part, will be apparent from the description, or may be learned by practice of the disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a two-dimensional (2D) scene observed from a viewpoint according to an embodiment;

FIG. 2 illustrates estimation of a scene component based on a neural network, according to an embodiment;

FIG. 3 is a flowchart illustrating a method of generating a scene image according to an embodiment;

FIGS. 4 and 5 illustrate estimation of BSDF values based on a first machine learning-based model and a second machine learning-based model, according to an embodiment;

FIG. 6 illustrates calculation of sequential light energy according to a path of ray tracing;

FIGS. 7 to 9 illustrate estimation of a lobe parameter based on a third machine learning-based model, according to an embodiment;

FIG. 10 is a flowchart illustrating training of a scene information estimation network, according to an embodiment;

FIG. 11 is a block diagram of a configuration of an electronic device, according to an embodiment; and

FIG. 12 illustrates an example of a scene image rendered by an electronic device, according to an embodiment.

### DETAILED DESCRIPTION

The following detailed structural or functional description is provided as an example only and various alterations and modifications may be made to the embodiments. Accordingly, the disclosure should not be construed as limited to the particular embodiments described below and should be understood to include all changes, equivalents, and replacements within the idea and the technical scope of the disclosure.

Although terms such as first, second, and the like are used to describe various components, the components are not limited to the particular terms that are used. These terms should be understood only to distinguish one component from another component. For example, a first component may be referred to as a second component, and similarly, the second component may also be referred to as the first component.

It should be noted that if one component is described as being “connected”, “coupled”, or “joined” to another component, a third component may be “connected”, “coupled”, and “joined” between the first and second components, or the first component may be directly “connected”, “coupled”, or “joined” to the second component.

As used herein, the singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. In particular, expressions such as “at least one of,” when preceding a list of elements, modify the entire list of elements and do not modify the individual elements of the list. For example, the expression, “at least one of A, B, and C,” should be understood as including only A, only B, only C, both A and B, both A and C, both B and C, or all of A, B, and C.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

As used herein, when an action or operation is referred to as occurring “in response to” an event or occurrence, this may mean that action or operation occurs directly or indirectly in response to or based on the event or occurrence.

Unless otherwise defined, all terms, including technical and scientific terms, used herein have the same meaning as commonly understood by one of ordinary skill in the art to which the present disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments are described in detail with reference to the accompanying drawings. When describing embodiments with reference to the accompanying drawings, like reference numerals refer to like elements and a repeated description related thereto will be omitted.

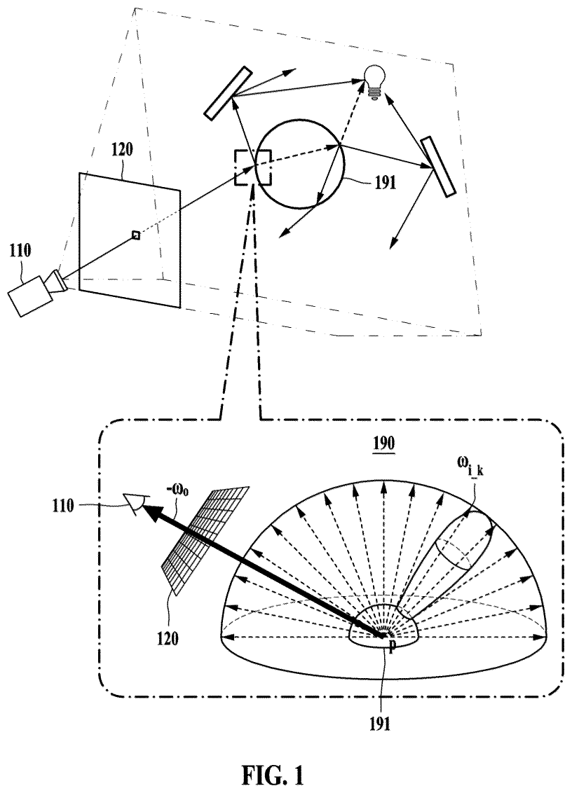

FIG. 1 illustrates a two-dimensional (2D) scene observed from a viewpoint according to an embodiment.

According to an embodiment, an electronic device may generate an image corresponding to a 2D scene 120 obtained by observing a 3D space 190 from a viewpoint 110. The viewpoint 110 may represent an arbitrary point for observing a scene in the 3D space 190. Referring to FIG. 1, the viewpoint 110 may be interpreted as a point at which a camera or an eye is positioned to view a scene in the 3D space 190 from a field of view (FOV). Although FIG. 1 illustrates the viewpoint 110 as a camera, embodiments are not limited thereto. For example, in some embodiments, the camera may be interpreted as an observer of the 2D scene 120 as a virtual camera for which which a view direction and the FOV are arbitrarily set rather than a real camera sensor. For example, the image corresponding to the 2D scene 120 described above may be interpreted as an image representing a scene captured by a virtual camera positioned at the viewpoint 110 in the 3D space 190 from an arbitrary FOV. The 3D space 190 described above may be a virtual space or an actual physical space.

The electronic device according to an embodiment may generate an image corresponding to the 2D scene 120 viewing an object 191 positioned in the 3D space 190 in an arbitrary view direction and FOV. For example, the electronic device may determine (or, for example, generate or calculate) image pixels corresponding to the viewpoint 110 and the view direction. The view direction from the viewpoint 110 may pass through a point (e.g., a point corresponding to an image pixel in an image of the 2D scene 120) in an image plane corresponding to the 2D scene 120. The view direction passing through the point corresponding to the image pixel may reach a point (e.g., a 3D point on the object 191) in the 3D space 190. A pixel value of the image pixel may be determined as image information (e.g., a color value) corresponding to a 3D point at which the view direction reaches on the object 191 and which is visible in a scene corresponding to the viewpoint 110. As described below, the electronic device may determine a pixel value of the image pixel based on physical properties of the 3D point (e.g., light projected onto the 3D point, a material of the 3D point). Herein, ωₒ may denote the view direction and p may denote a first encountered 3D point in the view direction from the viewpoint 110 (e.g., a position of a virtual camera). The information indicating the 3D point p may be referred to as point information and may include 3D coordinates. The 3D point p may also be referred to as a surface position of the object 191.

The electronic device according to an embodiment may estimate scene component information based on one or more machine learning-based models. According to embodiments, a machine learning-based model may refer to a model that is trained or learned using machine learning training or artificial intelligence training. For example, a machine learning-based model may be, or may include, at least one of a machine learning model and an artificial intelligence model, for example at least one of a regression model, a decision tree model, a classification model, a random forest model, a neural network model, a support vector machine (SVM), and any other type of model or combination thereof. The scene component information may be information indicating physical properties of each point in the scene and may be used for physics-based rendering.

The computation of a color value (e.g., a red green blue (RGB) value) of a 3D point by a rendering equation, which may refer to an equation used in the computer graphics field for physics-based rendering, may be highly complex. The electronic device in an embodiment may calculate a pixel value (e.g., a color value) for each pixel from the scene property information using an approximated rendering equation modified from the rendering equation.

To realistically render a virtual 3D scene, it may be beneficial to accurately calculate the movement, reflection, and transmission of light (e.g., rays) by considering a physical property (e.g., geometry, a material, and a light condition) of the scene. In the field of computer graphics, a rendering equation that models various physical properties and interaction of light may be, for example, an equation that approximates reflection and refraction properties of a material based on microfacet theory, and may be expressed according to Equation 1 below.

$${L}_{o} ( p , {ω}_{o} ) = {\int }_{Ω} {f}_{r} ( p , {ω}_{i} , {ω}_{o} ) {L}_{i} ( p , {ω}_{i} ) ( {ω}_{i} \cdot n ) d {ω}_{i} \qquad [ Equation 1 ]$$

In Equation 1, Lₒ may denote a total amount of light energy in which light Lᵢ that is incident on an arbitrary 3D point p from all directions Ω travels (e.g., propagates, reflects, and/or transmits) in an arbitrary ray direction ω₀ by a material property (e.g., material reflectivity and/or material transmittance). The directions Ω may be a set of direction vectors passing through a sphere with a normal vector n as a center. In addition, ωᵢ may denote a direction of a ray starting from the 3D point p and may be one of light vectors corresponding to all directions Ω. Further, ω₀ may denote a vector corresponding to the view direction viewed by the camera, and is illustrated and described herein in an aspect of ray tracing as an example. According to embodiments, in the rendering aspect, an outgoing vector −ωₒ may be described. Also, n may denote a normal vector at the 3D point p. In this case, Lₒ may be interpreted as a pixel value (e.g., an RGB color value) of the image pixel shown at the viewpoint 110. Accordingly, Equation 1 may be interpreted as a rendering equation that models various light energies incoming to the 3D point p to outgoing light energy (e.g., a color value visible at a pixel position corresponding to the 3D point p) toward the viewpoint 110 through the 3D point p.

In Equation 1 described above, the scene component information may include physical properties, for example, a fᵣ(p, ωᵢ, ωₒ) component (hereinafter, also referred to as fᵣ) as a material component and a Lᵢ(p, ωᵢ) component as a light component. The fᵣ component may be mathematically modeled and expressed according to a bidirectional scattering distribution function (BSDF). The BSDF component may be an important element for calculating realistic light reflection and transmission, and may be a reflectance distribution function indicating a degree of reflection or transmission of a ray of light in a different direction when the ray of light is incident on a point on a surface having a specific material. The BSDF component may include a bidirectional reflectance distribution function (BRDF) component and a bidirectional transmittance distribution function (BTDF) component. The BRDF component may be a component indicating a reflectance distribution on a surface of an object, and the BTDF component may be a component indicating a transmittance distribution for the object.

According to a comparative embodiment, a material function that ignores transmission and considers only the reflection of light at a specific point may be used. For a BRDF value included in a high dynamic range (HDR), a cosine value of an incident angle may be multiplied and a value may be compressed by applying the logarithm. Additionally, in sampling for a reflection path of light, Blinn-Phong parameters of the material may need to be provided in advance. In the comparative embodiment, only the reflection of light may be considered for estimation of the material and the light may be sampled by a simple BRDF model. Accordingly, it may be difficult to apply the comparative embodiment to a typical object having different material properties for different surface points. Additionally, because the comparative embodiment may use a compressed BRDF value by applying a logarithmic function, a loss may occur in scene restoration. Because only the reflection is considered, scene restoration may be difficult for a transparent material.

The electronic device according to an embodiment may estimate a BSDF value across a plurality of ranges as described below. Accordingly, at least some embodiments described below may estimate a more accurate BSDF value. Additionally, the electronic device may sample a direction (e.g., ray direction), in which a ray corresponding to the view direction (e.g., ωₒ) travels (e.g., reflects, transmits, and/or propagates) at the 3D point p, based on a probability distribution (e.g., a spherical Gaussian (SG) probability distribution) corresponding to a plurality of lobes. Accordingly, the electronic device may realistically render a material having a complex physical property in real-time.

The electronic device may render a high-quality 3D scene under various conditions (e.g., a view, a material, and a light). The electronic device may render the realistic 2D scene 120 for visualization of a 3D scene according to various applications, for example at least one of a metaverse application and a 3D game application. When the electronic device is implemented as a mobile device, the electronic device may provide a realistic experience to a user without spatial limitations.

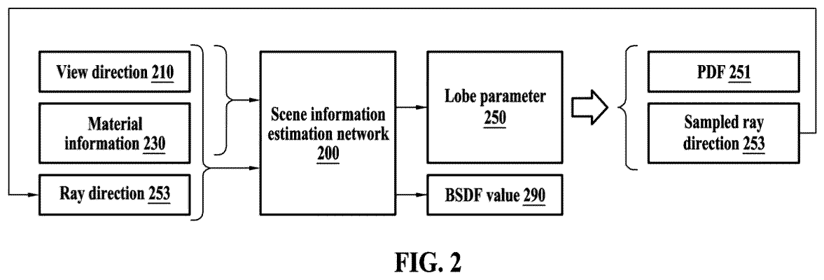

Hereinafter, with reference to FIG. 2, a network structure (e.g., a scene component estimation network) for estimating scene component information (e.g., a BSDF value) and inference (e.g., estimation) of the scene component information using a scene component estimation network are described according to an embodiment.

FIG. 2 illustrates estimation of a scene component based on a neural network, according to an embodiment.

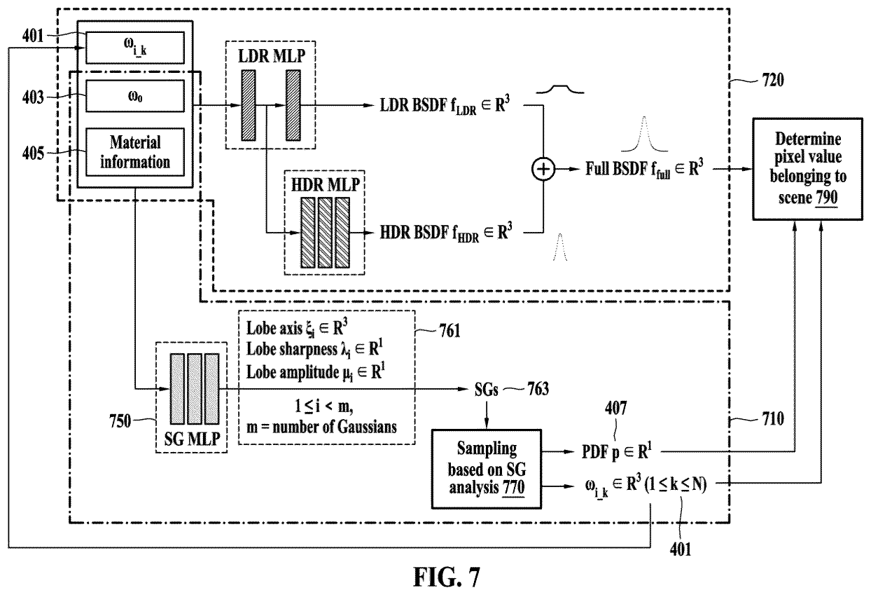

An electronic device in an embodiment may estimate scene component information based on a scene information estimation network 200. For example, the electronic device may estimate a lobe parameter 250 and a BSDF value 290 from a view direction 210, material information 230, and a ray direction 253, based on the scene information estimation network. For example, the scene information estimation network 200 may include a plurality of machine learning-based models (e.g., a first machine learning-based model, a second machine learning-based model, and a third machine learning-based model). As described below, the first machine learning-based model and the second machine learning-based model may be designed and trained to respectively output partial BSDF values 290 from or based on the sampled ray direction 253, the view direction 210, and the material information 230. The third machine learning-based model may be designed and trained to output the lobe parameter 250 from or based on the view direction 210 and the material information 230. In this case, the sampled ray direction 253 provided to the first and second machine learning-based models may be sampled using a probability density function (PDF) 251 derived based on the lobe parameter 250 output from the third machine learning-based model. The PDF 251 may be a probabilistic density function for a direction in which light incident on the 3D point p in the view direction 210 travels and may be a sum of the plurality of lobes described above. Because the sum of probabilities may be a value of one (“1”), the PDF aggregating the plurality of lobes may be normalized so that the sum of probabilities thereof has a value of one (“1”). The lobe parameter 250 may be a parameter for defining a lobe indicating a probability distribution of a potential traveling direction of light incident on the 3D point p in the view direction 210. Examples of the lobe and the lobe parameter are further described with reference to FIG. 7 below.

The machine learning-based models may include a neural network. The neural network included in each machine learning-based model may be, or may include, a multi-layer perceptron (MLP) network. Herein, the neural network may include a layer and each layer may include a node. The node may have a node value determined based on an activation function. A node of a layer may be connected to a node of another layer (e.g., another node) using a link (e.g., a connection edge) having a connection ωeight. A node value of the node may be propagated to other nodes using the link. For example, in an inference operation of the neural network, node values may be forward propagated from a previous layer to a next layer. A node value of a node may be propagated (e.g., forward propagation) to a node of a next layer (e.g., a next node) connected to the node using a connection edge. For example, the node may receive a weighted value by a connection ωeight from a previous node (e.g., a plurality of nodes) connected using the connection edge. The node value of the node may be determined based on a value obtained by applying the activation function to a sum (e.g., a weighted sum) of weighted values received from the previous nodes. The parameter of the neural network may include the connection ωeight described above as an example. The parameter of the neural network may be updated to change an objective function value described below in a targeted direction (e.g., minimizing a loss).

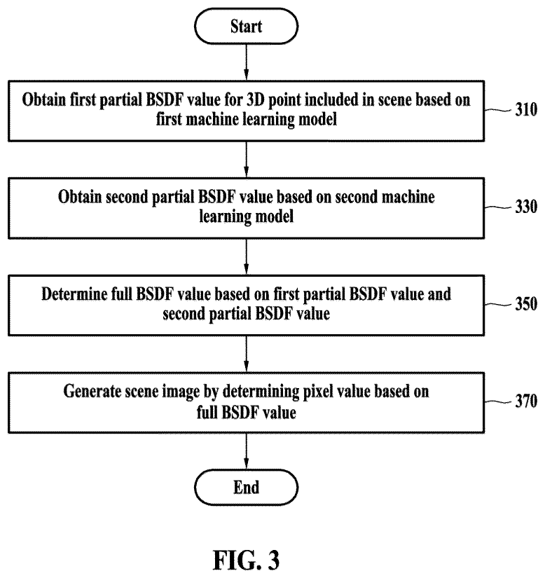

FIG. 3 is a flowchart illustrating a method of generating a scene image according to an embodiment.

At operation 310, an electronic device may obtain a first partial BSDF value for a 3D point included in a scene, using a first machine learning-based model. For example, the electronic device may select a 3D point included in a scene corresponding to a viewpoint. The electronic device may obtain the first partial BSDF value based on the first machine learning-based model based on a view direction facing the 3D point from the viewpoint, a ray direction sampled at the 3D point, and material information. The first partial BSDF value may be a value corresponding to a portion of a full BSDF value corresponding to the sampled ray direction. The first machine learning-based model may be a neural network that is designed and trained to output the first partial BSDF value from the view direction, the sampled ray direction, and the material information and may be, for example, an MLP model.

At operation 330, the electronic device may obtain a second partial BSDF value using a second machine learning-based model. The electronic device may obtain the second partial BSDF value using the second machine learning-based model, and the second machine learning-based model may be connected to the first machine learning-based model. The second partial BSDF value may be a value corresponding to another portion of the full BSDF value corresponding to the sampled ray direction. The second machine learning-based model may be a neural network that is designed and trained to output the second partial BSDF value based on an output (e.g., a propagated value) of at least one layer (e.g., an intermediate layer) of the first machine learning-based model.

At operation 350, the electronic device may determine a full BSDF value based on the first partial BSDF value and the second partial BSDF value. The electronic device may determine a full BSDF value for the ray direction of the 3D point based on the first partial BSDF value and the second partial BSDF value.

At operation 370, the electronic device may generate a scene image by determining a pixel value based on the full BSDF value. The electronic device may generate an image corresponding to the scene by determining a value of a pixel corresponding to the view direction based on the sample dray direction, the full BSDF value, and a PDF value.

In some embodiments, Equation 2 below may be used as the rendering equation. In Equation 2, the continuous integral of Equation 1 described above is transformed into a discontinuous discrete sigma sum based on Monte-Carlo estimation. The electronic device may calculate the reflection of light energy incident continuously in a 3D area through Equation 2 below as the rendering equation.

$${L}_{o} ( p , {ω}_{o} ) = \frac{1}{N} {\sum }_{k = 1}^{N} \frac{{f}_{r} ( p , {ω}_{i \_ k} , {ω}_{o} ) {L}_{i} ( p , {ω}_{i \_ k} ) ( {ω}_{i \_ k} \cdot n )}{pdf ( p , {ω}_{i \_ k} , {ω}_{o} , n )} \qquad [ Equation 2 ]$$

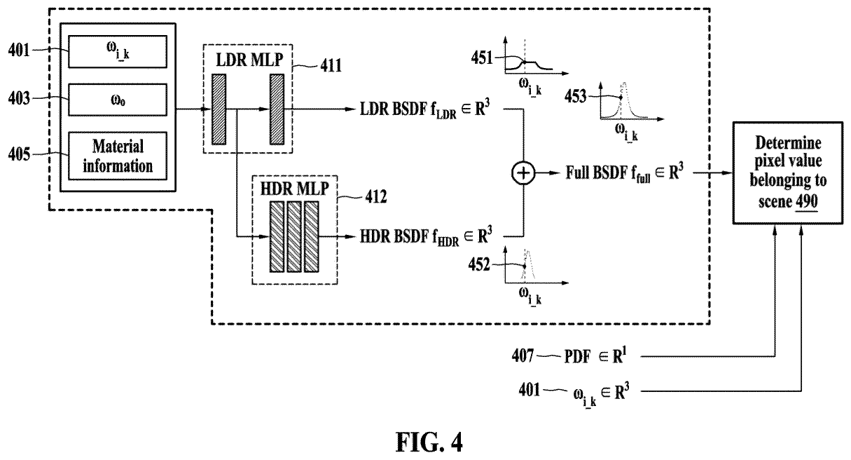

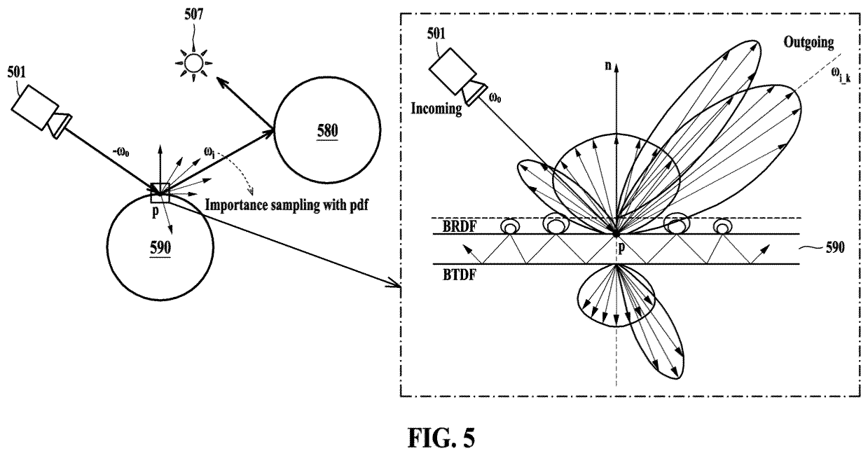

In Equation 2 above, fᵣ may denote a BSDF value corresponding to a sampled ray direction ω_{i_k} at a 3D point p and an outgoing direction ω. (e.g., a view direction −ωₒ). In addition, Lᵢ may denote incoming light information in the sampled ray direction ω_{i_k} at the 3D point p. Further, n may be a normal vector at the 3D point p. The expression pdf(p, ω_{i_k}, ωₒ, n) may denote a PDF value corresponding to the ray direction ω_{i_k} at the 3D point p, the view direction −ωₒ, and the normal vector n. In Equation 2, which may be referred to as a transformed rendering equation, a PDF may be used according to a material distribution function value. Additionally, to perform ray tracing, the sampled ray direction as a next path of light after being reflecting and transmitted may be sampled in a probabilistically significant direction based on the PDF. Examples of the BSDF value are described with reference to FIGS. 4 and 5 below, and examples of sampling the ray direction and estimating the PDF are described with reference to FIGS. 7 to 9.

When an object including a transparent material is included in the scene, the electronic device according to an embodiment may generate a frame image corresponding to the scene within a threshold time (e.g., a threshold period of time) by determining a pixel value corresponding to a BSDF value estimated based on a ray direction that passes through the object. For example, in some embodiments, the threshold time for one frame may be less than or equal to 30 milliseconds (ms), but embodiments are not limited thereto. Accordingly, the electronic device may render a scene image for a reflective material and a transparent material in real-time even when a view change (e.g., a change in a viewpoint and/or a view direction) occurs in the 3D space. Herein, real-time rendering may refer to rendering which targets 60 frame per seconds (fps), which may be imperceptible to humans.

FIGS. 4 and 5 illustrate estimation of BSDF values based on a first machine learning-based model and a second machine learning-based model, according to an embodiment.

An electronic device according to an embodiment may estimate partial BSDF values (e.g., a first partial BSDF value 451 and a second partial BSDF value 452) based on a view direction 403 −ωₒ, a ray direction ω_{i_k}, and material information 405 using a plurality of machine learning-based models. The material information 405 may be information indicating a material of (e.g., correspond to or associated with) a 3D point, and may include, for example, albedo a and roughness r. For example, a second machine learning-based model 412 of the plurality of machine learning-based models may be connected to a first machine learning-based model 411. The second machine learning-based model 412 may be connected to the first machine learning-based model 411 in order to receive an output of an intermediate layer of the first machine learning-based model 411. Each of the first machine learning-based model 411 and the second machine learning-based model 412 may be an MLP model.

According to embodiments, a sampled ray direction 401 (denoted as ω_{i_k}) that is used for estimating a BSDF value may be a direction selected based on importance sampling. The electronic device may sample a highly probable direction among potential candidate directions in which light may travel (e.g., propagate, reflect, and/or transmit) according to a physical phenomenon at a surface position p on the object, based on importance. A probability distribution of directions in which light incident on a surface of an object 590 may travel may be expressed by a plurality of lobes having different shapes depending on a travel type (e.g., specular reflection, diffuse reflection, and transmission). The ray direction 401 (ω_{i_k}) may be selected from the potential candidate directions corresponding to the lobes.

For example, referring to FIG. 5, an example of a propagation path of light is illustrated. Because a direction of the propagation path of the light is illustrated in the perspective from ray tracing, the direction is illustrated from a camera 501 to lighting 507. An object surface position p may be a position of a point apart from a viewpoint in the view direction 403 (denoted as −ωₒ), and may indicate a surface position on an object 590. Referring to FIG. 5, light (e.g., indirect light and/or direct light) may enter in the sampled ray direction 401 (ω_{i_k}) starting from the object surface position p. Although FIG. 5 illustrates an example in which ray directions are directions toward a sphere centered at the object surface position p, embodiments are not limited thereto, and ray directions may vary depending on a geometric shape of the object surface. FIG. 5 illustrates a path in which light emitted from the lighting 507 is reflected off another object 580, passes through the surface position p on the object 590, and reaches the camera 501. In this case, a ray direction ω_{i_k} from the object 590 to another object 580 may be a direction selected based on importance sampling as described above. Examples of sampling the ray direction ω_{i_k} are further described with reference to FIGS. 7 to 9 below.

The electronic device may determine a first partial BSDF value 451 by providing the view direction 403 (−ωₒ), the sampled ray direction 401 (ω_{i_k}), and the material information 405 to the first machine learning-based model 411. In addition, the electronic device may determine a second partial BSDF value 452 by providing a value propagated from the intermediate layer of the first machine learning-based model 411 to the second machine learning-based model 412 (e.g., by propagating a value from the intermediate layer of the first machine learning-based model 411 to the second machine learning-based model 412). The first partial BSDF value 451 may be a value corresponding to a first range, and the second partial BSDF value 452 may be a value corresponding to a second range. The first range and the second range may not overlap each other, and the second range may be higher than the first range. For example, the second range may be a range exceeding a threshold value (e.g., a value of one (“1”)) and may indicate HDR and the first range may be a range less than or equal to the threshold value (e.g., between a value of zero (“0”) and a value of one (“1”)) and may indicate low dynamic range (LDR). According to embodiments, the BSDF value may be distributed over a wide range depending on a material property. Additionally, the BSDF value may not be evenly distributed over a wide range, may have a large value (e.g., an HDR value) only at a specific incident angle and a specific reflection angle, and may have a small value (e.g., an LDR value) that may be, for example, less than or equal to a value of one (“1”) at other angles. When a single MLP model is designed and trained to output an LDR value and an HDR value, the accuracy may be deteriorated. According to embodiments, for more accurate estimation, the electronic device may estimate an LDR component using an LDR MLP model (e.g., the first machine learning-based model 411) and may estimate an HDR component using an HDR MLP model (e.g., the second machine learning-based model 412). In a full BSDF value f_{full}, because a component value (e.g., the first partial BSDF value 451 (denoted as f_{LDR})) corresponding to the LDR and a component value (e.g., the second partial BSDF value 452 (f_{HDR})) corresponding to the HDR may be values in different areas in the same BSDF function, the second machine learning-based model 412 may share some layers of the first machine learning-based model 411 in order to use a common feature for estimating the partial BSDF values. Although FIG. 4 illustrates an output of a first layer of the first machine learning-based model 411 is propagated to the second machine learning-based model 412, the example is not limited thereto. For example, in some embodiments, an output of another layer (e.g., a layer different from the first layer) of the first machine learning-based model 411 may be propagated to the second machine learning-based model 412.

The electronic device may determine a full BSDF value 453 (denoted as f_{full}) based on the first partial BSDF value 451 (f_{LDF}) and the second partial BSDF value 452 (f_{HDR}). For example, the electronic device may determine the full BSDF value 453 (f_{full}) by aggregating the first partial BSDF value 451 (f_{LDR}) and the second partial BSDF value 452 (f_{HDR}). Although FIG. 4 illustrates an example which includes both the BSDF distribution and the BSDF value for ease of understanding, values estimated based on the machine learning-based models may be values corresponding to the sampled ray direction 401 (ω_{i_k}) in the BSDF distribution that may be shown under a given condition (e.g., the view direction 403 (−ωₒ) and the material information 405). For example, the first partial BSDF value 451 (f_{LDR}) estimated based on the first machine learning-based model 411 may indicate a component value corresponding to the LDR of the full BSDF value corresponding to the sampled ray direction 401 (ω_{i_k}). Similarly, the second partial BSDF value 452 (f_{HDR}) estimated based on the second machine learning-based model 412 may indicate a component value corresponding to the HDR of the full BSDF value corresponding to the sampled ray direction 401 (ω_{i_k}). The second partial BSDF value 452 (f_{HDR}) may be a value obtained by subtracting a threshold value from the full BSDF value 453 (f_{full}). For example, when the full BSDF value 453 (f_{full}) is sixteen (“16”), the first partial BSDF value 451 (f_{LDR}) may be one (“1”) and the second partial BSDF value 452 (f_{HDR}) may be fifteen (“15”). Accordingly, the electronic device may obtain 16 as the full BSDF value 451 (f_{full}) by simply aggregating the first partial BSDF value 451 (f_{LDR}) and the second partial BSDF value 452 (f_{HDR}).

At operation 490, the electronic device may determine a pixel value belonging to the scene. For example, the electronic device may determine a pixel value of a pixel corresponding to the view direction 403 based on the full BSDF value 453 (f_{full}) determined in FIG. 4, a PDF 407 for a direction in which a ray may potentially travel according to the view direction 403, and the sampled ray direction 401. The electronic device may calculate the corresponding pixel value according to Equation 2 described above. The electronic device may generate a scene image by determining pixel values of all pixels belonging to the scene corresponding to the viewpoint.

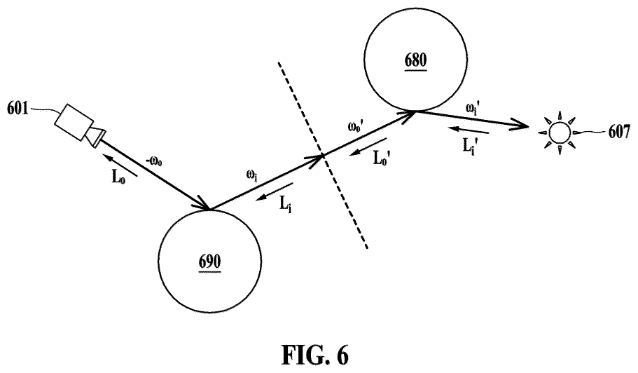

FIG. 6 illustrates calculation of sequential light energy according to a path of ray tracing.

An electronic device in an embodiment may find points (e.g., 3D points) at which light energy moves and collides in a 3D space based on ray tracing. The electronic device may iteratively perform or calculate the rendering equation described above at each selected point. The electronic device may determine a pixel value (e.g., a color value) of a scene image coming into a camera (or human eyes) as light energy starting from a light source repeats reflection and transmission from various object surfaces through iterative calculation of the rendering equation according to Equation 2.

For example, in the example illustrated in FIG. 6, the electronic device may sample a ray direction ωᵢ from a 3D point p of an object 690 in response to a ray incident on the object 690 in a view direction −ωₒ from the camera 601. The electronic device may perform additional ray sampling in response to a ray that travels in the sampled ray direction ωᵢ encountering another object 680. In this case, the sampled ray direction ωᵢ may be considered as the view direction −ω′ₒ for the another object 680. The electronic device may sample the ray direction ω′ᵢ for incidence of the ray in the view direction −ω′ₒ. Because the ray direction ω′ᵢ may be oriented to lighting 607, in the example illustrated in FIG. 6, light emitted from the lighting 607 may travel along a path according to the ray direction ω′ᵢ, the ray direction ωᵢ, and the view direction −ωₒ. The electronic device may determine light energy L′ₒ according to Equation 2 described above from the view direction −ω′ₒ, the ray direction ω′ᵢ, and light information L′ᵢ of the another object 680. In this case, the BSDF value used for Equation 2 may be determined by the operations described above with reference to FIG. 4. The light energy L′ₒ may be used as the light information Lᵢ for the object 690. The electronic device may determine light energy Lₒ according to Equation 2 described above from the view direction −ωₒ, the ray direction ωᵢ, and light information Lᵢ of the object 690. As described above, the light energy Lₒ may be a pixel value of a pixel corresponding to the view direction −ωₒ in the scene corresponding to the viewpoint. Accordingly, the electronic device may determine a value of a pixel (e.g., a color value) belonging to the scene by sequentially determining the light energy according to Equation 2 at a 3D point (e.g., a collision point between light and an object) identified based on ray tracing.

FIGS. 7 to 9 illustrate estimation of a lobe parameter based on a third machine learning-based model, according to an embodiment.

An electronic device in an embodiment may perform an operation 710, which may be referred to as a ray sampling operation, and an operation 720, which may be referred to as a BSDF estimation operation. According to embodiments, the operation 720 may be similar to the operations described above with reference to FIGS. 4 and 5. Therefore, redundant or duplicative description thereof may be omitted. The sampled ray direction 401 (ω_{i_k}) described with reference to FIG. 4 may be determined by the operation 710 described below. The operation 710 may include estimation of a parameter (e.g., a lobe parameter 761) that defines a lobe modeling a potential traveling direction of a ray incident on a 3D point, determination of the PDF 407 based on the lobe, and sampling of a ray direction based on the PDF 407.

At operation 710, the electronic device may sample the ray direction based on a plurality of lobes (e.g., an SG probability distribution 763) corresponding to at least one of potential reflection and transmission at the 3D point. For example, the electronic device may estimate SG parameters respectively corresponding to the plurality of lobes based on a third machine learning-based model 750. A lobe parameter 761 may be estimated based on the third machine learning-based model 750 based on the view direction 403 (−ωₒ) and the material information 405. The lobe parameter 761 may be a parameter that defines a lobe indicating a pattern (e.g., a PDF of a traveling direction of light) in which light incident on a 3D point p travels in the view direction 403 (−ωₒ).

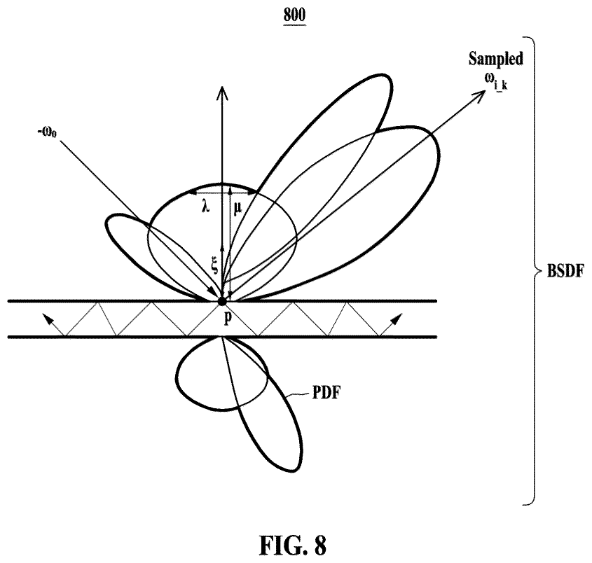

Each lobe may be modeled as the SG probability distribution 763, for example. The electronic device may estimate the lobe parameter 761 for each of the plurality of lobes (e.g., lobes corresponding to specular reflection, diffuse reflection, and transmission). An example 800 illustrated in FIG. 8 shows examples of a potential traveling direction pattern of light, including for example specular reflection, secondary specular, diffuse reflection, backwards reflection, diffuse transmitted, and specular transmitted types of lobes.

The lobe parameter 761 may be an SG parameter, and the SG parameter may include at least one of an axis ξ of a corresponding lobe, amplitude μ, or sharpness λ, for example. The lobe axis ξ may represent a center direction of the lobe. As the lobe amplitude μ (or intensity) of the lobe increases, the length of the lobe according to the lobe axis ξ may increase, and as the lobe amplitude μ decreases, the length of the lobe may decrease. As the lobe sharpness λ increases, the lobe may become thinner and as the lobe sharpness λ decreases, the lobe may thicken.

The SG distribution may express a one-dimensional (1D) Gaussian distribution (or a normal distribution) in the form of 3D lobes and may be expressed by Equation 3 below using the lobe parameter 761 described above.

$$G ( v ; u , λ , a ) = a {e}^{λ ( u \cdot v - 1 )} \qquad [ Equation 3 ]$$

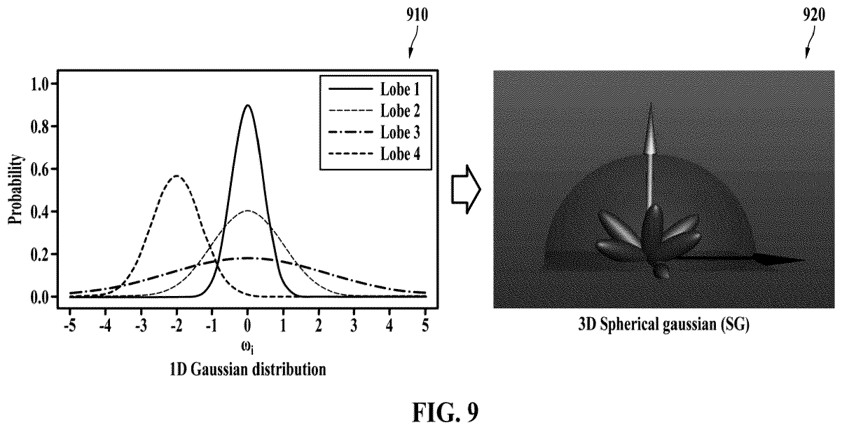

In Equation 3, a may be an amplitude μ (or intensity) of a lobe, and may denote a height of the lobe at a peak. In addition, u may be a direction toward the center of the lobe and may denote an axis ξ of the lobe. Further, λ may denote a sharpness of the lobe. In addition, ν may be an input direction vector for a 3D point that is a starting point of the lobe and may denote the view direction 403 (−ωₒ) according to embodiments. In FIG. 9, for convenience of explanation, a 3D Gaussian distribution 920 corresponding to a plurality of lobes following the Gaussian distribution and a 1D Gaussian distribution 910 that interprets the 3D Gaussian distribution 920 in one dimension are illustrated. An SG lobe may have a similar shape to a BSDF lobe, may have a simple parameter, and may be expressed by a simple equation as Equation 3 described above. The BSDF lobe may be a lobe indicating a potential traveling direction of light incident on the 3D point according to the BSDF. Accordingly, the relatively complex BSDF lobes illustrated in FIG. 8 may be expressed as relatively simple SG lobes according to Equation 3 described above. The electronic device may obtain the PDF 407 (e.g., PDF_{summed_lobe}) in which the lobes are summed.

$$P D {F}_{summed \_ lobe} = {\sum }_{k}^{M} G ( v ; {u}_{k} , {λ}_{k} , {a}_{k} ) \qquad [ Equation 4 ]$$

In Equation 4, M may be an integer greater than or equal to 1 and k may be an integer less than or equal to M. As described above, the summed PDF_{summed_lobe} of the SG lobes may be normalized by the PDF 407 where the sum of probabilities is a value of one (“1”).

Although FIG. 8 illustrates an example including six BSDF lobes, embodiments are not limited thereto. For example, according to embodiments, the number of BSDF lobes may vary depending on modeling. Because the number of lobes may be flexibly extended, an accurate PDF 407 may be determined for more complex BSDF modeling. In FIG. 7, m SG distribution lobes may be estimated, and a lobe axis ξᵢ for an i-th lobe, a lobe sharpness λᵢ for the i-th lobe, and a lobe amplitude μᵢ for the i-th lobe may be estimated. In this case, m may be an integer greater than or equal to 2, and i may be greater than or equal to one (“1”) and less than m. Because the number of lobes may be freely set, the method according to an embodiment may be universally applied to a complex light reflection model.

The electronic device may estimate the lobe parameter 761 for each of a predetermined number of BSDF lobes. The estimation of the lobe parameter 761 may use the material information 405 (e.g., information on the physical property of the material) and the view direction 403 (−ωₒ) as inputs, and (in at least some embodiments) may not use a ray direction (e.g., a reflection direction and/or a transmission direction) as an input. In the third machine learning-based model 750 described above, the lobe parameter 761 estimated from the material information 405 and the view direction 403 may be used for determining the PDF 407 and ray sampling described below.

At operation 770, the electronic device may perform sampling (e.g., analytic sampling) based on an SG analysis. The electronic device may determine the PDF 407 corresponding to at least one of the reflection and the transmission of the ray at the 3D point based on the SG probability distribution 763 in which the plurality of lobes is individually modeled. For example, the electronic device may obtain the PDF 407 from the lobe parameter 761. As described above, the PDF 407 may be a normalized sum of probability distributions (e.g., the SG probability distribution 763) according to a lobe defined by the lobe parameter 761. The electronic device may sample the ray direction based on the determined PDF. The electronic device may sample the ray direction based on importance sampling using the PDF 407. For example, the electronic device may generate a random number using the PDF 407, and may select the ray direction corresponding to the greatest random number from the generated random numbers.

According to embodiments, when many random numbers are generated using the PDF 407, random numbers may be generated in a biased distribution similar to the PDF 407 according to the law of large numbers. Herein, because the example in which N=1 or N=2 is satisfied is described related to Equation 2, sampling may be performed once or twice, but it may be probabilistically highly likely that a ray direction at or close to the center of the PDF 407 is selected. However, it is not probabilistically excluded that a ray direction other than the center of the PDF 407 or close to the center is selected. Accordingly, the electronic device may sample the ray direction with randomness while following the tendency corresponding to the PDF 407.

At operation 720, which may be referred to as the BSDF estimation operation, the electronic device may estimate a full BSDF value based on the sampled ray direction 401 (ω_{i_k}), the view direction 403 (−ωₒ), and the material information 405.

At operation 790, the electronic device may determine a pixel value belonging to the scene. For example, the electronic device may determine the pixel value based on the full BSDF value, the PDF 407, and the sampled ray direction 401 (ω_{i_k}). As described above, the electronic device may determine the pixel value according to Equation 2. The electronic device may render the scene image in real-time by determining pixel values of all pixels of the scene image for the 3D space within a threshold time. Accordingly, the electronic device may perform realistic physics-based rendering in a mobile device. In addition, the electronic device may infer the full BSDF value and the sampled direction for a complex material with less computational power compared to the comparative embodiments. The scene information estimation network may be customized for a mobile device using additional lightweighting. The electronic device may further enhance the rendering speed by utilizing both a graphics processing unit (GPU) and a neural processing unit (NPU). BSDF values in the HDR and LDR may be accurately represented and rendering may be extended to reflective and transparent materials. Accordingly, various real materials in a real space may be learned and represented. An object may have different material properties (e.g., spatially varying BSDFs) for each 3D surface point. For detailed material representation, high-resolution texture resources may be used. The electronic device may encode and store high-resolution texture resources.

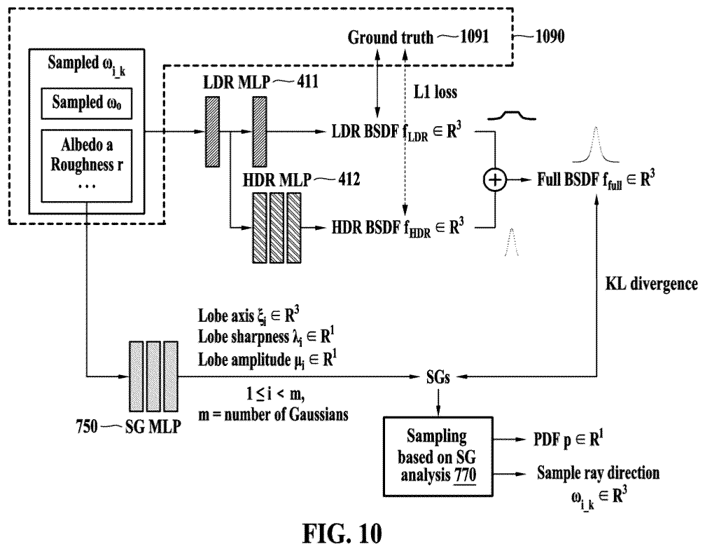

FIG. 10 is a flowchart illustrating training of a scene information estimation network, according to an embodiment.

The scene information estimation network according to an embodiment may be trained based on training data 1090. For example, a separate training device may update parameters (e.g., connection ωeights between nodes) of models of the scene information estimation network, but the example is not limited thereto. An electronic device for inference may update parameters of machine learning-based models.

The training data 1090 may include an image corresponding to a scene in a 3D space, material information at a 3D point on an object, and a BSDF true value 1091 (illustrated as “Ground truth”) according to a view direction and a ray direction. The BSDF true value 1091 may be a pre-calculated and/or measured BSDF value for a view direction and a ray direction at a specific point having specific material information in the 3D space. The BSDF true value 1091 may be divided into an HDR true value and an LDR true value. For example, when the BSDF true value 1091 is less than or equal to a threshold value, the HDR true value may be zero (“0”) and the LDR true value may be the BSDF true value 1091. As another example, when the BSDF true value 1091 exceeds a threshold value, the LDR true value may be the threshold value, and the HDR true value may be a value obtained by subtracting the threshold value from the BSDF true value 1091. The BSDF true value 1091 may be obtained from various datasets.

The training device may set various material information for each 3D point (e.g., a surface point) of the object and may select (e.g., randomly select) a view direction and a ray direction. The training device may use the selected view direction, ray direction, material information, and the BSDF true value 1901 as the training data 1090. The view direction, the ray direction, and the material information may be training inputs. The LDR true value and the HDR true value may be training outputs. The training device may estimate a temporary LDR value by providing the view direction, the ray direction, and the material information to the temporary first machine learning-based model 411. Herein, the temporary model may refer to a model before training is completed (e.g., a model that is untrained or partially trained).

Additionally, the training device may estimate a temporary HDR value by providing a value propagated from an intermediate layer of the temporary first machine learning-based model to the temporary second machine learning-based model 412. The training device may update parameters of the temporary models (e.g., the temporary first machine learning-based model 411 and the temporary second machine learning-based model 412) based on an objective function value (e.g., a loss) between the temporary outputs (e.g., the temporary HDR value and the temporary LDR value) and the true value. For example, the training device may update the parameter of the temporary first machine learning-based model 411 based on backpropagation of an L1 loss between the temporary HDR value and the HDR true value. Similarly, the training device may update the parameter of the temporary second machine learning-based model 412 based on backpropagation of an L1 loss between the temporary LDR value and the LDR true value. The training device may iteratively update the parameter until the objective function value converges or reaches a predetermined value. For reference, in FIG. 10, training based on the loss between the temporary LDR value and the LDR true value and the loss between the temporary HDR value and the HDR true value is described, but is not limited thereto. The parameters of the temporary machine learning-based models may be updated based on a loss (e.g., the L1 loss) between the BSDF true value 1091 and a temporary BSDF value calculated based on the temporary LDR value and the temporary HDR value.

The training device may estimate a temporary lobe parameter based on the view direction and the material information of the training data 1090 based on the temporary third machine learning-based model 750. The training device may restore a lobe (e.g., the SG probability distribution) based on the temporary lobe parameter. For example, the training device may generate temporary lobes from the temporary lobe parameter based on Equation 3 described above. The training device may obtain a temporary PDF based on a normalized sum of the temporary lobes. In this case, the distribution shape of BSDFs may be similar to the shape of the PDF. Accordingly, the training device may update the parameter of the temporary third machine learning-based model based on a loss (e.g., a KL divergence loss) between the BSDF distribution and the temporary PDF. Similarly, the training device may iteratively update the parameter until the loss converges or reaches a determined value. According to embodiments, as described above, the full BSDF value obtained based on estimation using the first machine learning-based model 411 and the second machine learning-based model 412 may be a BSDF value in one view direction and one sampled ray direction. Accordingly, the training device may obtain the BSDF distribution by estimating the BSDF values for various ray directions in the given view direction. The training device may train the third machine learning-based model 750 to output the PDF similar to the BSDF distribution.

The training device in an embodiment may efficiently train a neural network to infer the three elements described above (e.g., the ray direction, the PDF, and the BSDF value). By using the trained scene information estimation network described above, the electronic device may render a complex and sophisticated material realistically and in real-time in a mobile device as well as a personal computer (PC).

In some embodiments, the first machine learning-based model 411 and the second machine learning-based model 412 for BSDF estimation may be trained independently of the third machine learning-based model 750 for estimating a lobe parameter, but embodiments are not limited thereto. For example, in some embodiments, all of the machine learning-based models may be trained together, for example in an integrated manner.

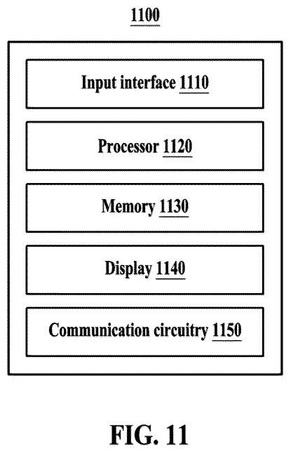

FIG. 11 is a block diagram of a configuration of an electronic device, according to an embodiment.

An electronic device 1100 according to an embodiment may include an input interface 1110, a processor 1120, a memory 1130, a display 1140, and a communication circuitry 1150. The electronic device 1100 may be a device for training the scene component estimation network and/or performing inference using the scene component estimation network described with reference to FIGS. 1 to 10. The electronic device 1100 may be, for example, an image processing device, a smartphone, a wearable device, a tablet computer, a netbook, a laptop, a desktop, or a personal digital assistant (PDA).

The input interface 1110, the processor 1120, the memory 1130, the display 1140, and the communication circuitry 1150 may communicate with each other using a communication bus.

The input interface 1110 may receive an input from a user through a haptic, video, audio, or touch input. The input interface 1110 may include a keyboard, a mouse, a touch screen, a microphone, or any other device that detects the input from the user and transmits the detected input.

The processor 1120 may execute instructions or functions to be executed in the electronic device 1100 (e.g., a computing device). For example, the processor 1120 may process the instructions stored in the memory 1130. The processor 1120 may extract various scene components (e.g., a sampled ray direction, a BSDF value, and a PDF) based on the scene information estimation network based on a view direction, a viewpoint, and material information corresponding to an image pixel corresponding to a 2D scene in an FOV at the viewpoint. The processor 1120 may select a 3D point included in the scene corresponding to the viewpoint. The processor 1120 may obtain the first partial BSDF value based on the first machine learning-based model from a view direction facing the 3D point from the viewpoint, a ray direction sampled at the 3D point, and material information. The processor 1120 may obtain the second partial BSDF value based on the second machine learning-based model, which may be connected to the first machine learning-based model. The processor 1120 may determine a full BSDF value for the ray direction at the 3D point based on the first partial BSDF value and the second partial BSDF value. The processor 1120 may generate an image corresponding to the scene by determining a value of a pixel corresponding to the view direction based on the sampled ray direction, the full BSDF value, and the PDF value. The processor 1120 may perform one or more operations described above with reference to FIGS. 1 to 9. The processor 1120 may also perform training described above with reference to FIG. 10.

The memory 1130 may store information or data necessary for the execution of the processor 1120. For example, the memory 1130 may store the machine learning-based models (e.g., the first, second, and third machine learning-based models) described above. Additionally, the memory 1130 may also store a training dataset. The memory 1130 may include a computer-readable storage medium or a computer-readable storage device. The memory 1130 may store instructions to be executed by the processor 1120 and may store related information while software and/or an application is executed by the electronic device 1100.

The display 1140 may visually provide an output of the electronic device 1100 to the user. For example, the display 1140 may display the scene image restored by the processor 1120 in real-time.

The communication circuitry 1150 may communicate with an external device using a wired or wireless network. The communication circuitry 1150 may also receive the machine learning-based models described above and a parameter (e.g., a trained parameter) of each machine learning-based model from an external device (e.g., a server).

The electronic device 1100 may perform high-quality 3D scene rendering in many different types of mobile devices in addition to a PC-class graphic device. The electronic device 1100 may render a realistic 3D scene in an application, such as a 3D game and a metaverse.

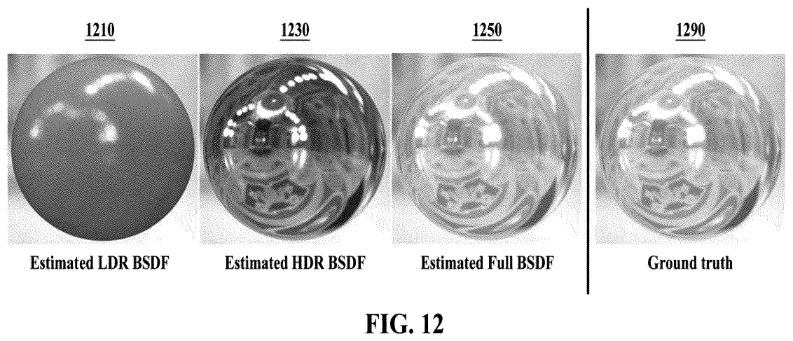

FIG. 12 illustrates an example of a scene image rendered by an electronic device, according to an embodiment.

An image 1210 restored by only an LDR component of a BSDF value in Equation 2 described above as an example, an image 1230 restored by only an HDR component of the BSDF value, and an image 1250 restored by a full BSDF value are illustrated. In the image 1210, a global visual feature of an object may be shown and in the image 1230, a local visual feature may be shown. In the image 1250 restored based on the full BSDF value obtained by the electronic device in an embodiment through the scene information estimation network described above, it may be identified that details of the global visual feature and the local visual feature are realistically rendered. The image may be restored to be the same as, or similar to a true value image 1290.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as compact disc-read only memory (CD-ROM) discs, digital versatile discs (DVDs), and/or Blu-ray discs; magneto-optical media such as optical discs; and hardware devices that are specially configured to store and perform program instructions, such as read-only memory (ROM), random access memory (RAM), flash memory (e.g., universal serial bus (USB) flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. An electronic device comprising:
at least one processor; and
a memory storing instructions,
wherein the instructions, when executed by the at least one processor, cause the electronic device to:
select a three-dimensional (3D) point included in a scene corresponding to a viewpoint,
using a first machine learning-based model, obtain a first partial bidirectional scattering distribution function (BSDF) value based on a view direction toward the 3D point from the viewpoint, a ray direction sampled at the 3D point, and material information,
obtain a second partial BSDF value using a second machine learning-based model, wherein the second machine learning-based model is connected to the first machine learning-based model,
determine a full BSDF value for the ray direction at the 3D point based on the first partial BSDF value and the second partial BSDF value, and
generate an image corresponding to the scene by determining a value of a pixel corresponding to the view direction based on the sampled ray direction, the full BSDF value, and a probability density function (PDF) value.

2. The electronic device of claim 1, wherein at least one of the first machine learning-based model and the second machine learning-based model comprises a multi-layer perceptron (MLP) layer model.

3. The electronic device of claim 1, wherein the instructions, when executed by the at least one processor, further cause the electronic device to determine the second partial BSDF value by propagating a value from an intermediate layer of the first machine learning-based model to the second machine learning-based model.

4. The electronic device of claim 1, wherein the first partial BSDF value corresponds to a first range and the second partial BSDF value corresponds to a second range,
wherein the first range does not overlap the second range, and
wherein the second range is higher than the first range.

5. The electronic device of claim 1, wherein the instructions, when executed by the at least one processor, further cause the electronic device to determine the full BSDF value by aggregating the first partial BSDF value and the second partial BSDF value.

6. The electronic device of claim 1, wherein the instructions, when executed by the at least one processor, further cause the electronic device to sample the ray direction based on a plurality of lobes corresponding to at least one of a potential reflection and a transmission at the 3D point.

7. The electronic device of claim 6, wherein the instructions, when executed by the at least one processor, further cause the electronic device to estimate a spherical Gaussian (SG) parameter corresponding to each lobe from among the plurality of lobes using a third machine learning-based model.

8. The electronic device of claim 7, wherein the SG parameter comprises at least one of an axis, a sharpness, and an amplitude of a corresponding lobe.

9. The electronic device of claim 6, wherein the instructions, when executed by the at least one processor, further cause the electronic device to:
determine a PDF corresponding to at least one of a reflection and a transmission of a ray at the 3D point based on a plurality of SG distributions in which the plurality of lobes is individually modeled, and
sample the ray direction based on the determined PDF.

10. The electronic device of claim 1, wherein the instructions, when executed by the at least one processor, further cause the electronic device to, based on determining that an object comprising a transparent material is included in the scene, generate a frame image corresponding to the scene within a threshold period of time by determining a corresponding pixel value using a BSDF value estimated based on a ray direction passing through the object.

11. A method, performed by a processor, of rendering a scene, the method comprising:
selecting a three-dimensional (3D) point included in a scene corresponding to a viewpoint;
using a first machine learning-based model, obtaining a first partial bidirectional scattering distribution function (BSDF) value based on a view direction toward the 3D point from the viewpoint, a ray direction sampled at the 3D point, and material information;
obtaining a second partial BSDF value using a second machine learning-based model, wherein the second machine learning-based model is connected to the first machine learning-based model;
determining a full BSDF value for the ray direction at the 3D point based on the first partial BSDF value and the second partial BSDF value; and
generating an image corresponding to the scene by determining a value of a pixel corresponding to the view direction based on the sampled ray direction, the full BSDF value, and a probability density function (PDF) value.

12. The method of claim 11, wherein at least one of the first machine learning-based model and the second machine learning-based model comprises a multi-layer perceptron (MLP) layer model.

13. The method of claim 11, wherein the obtaining of the second partial BSDF value comprises determining the second partial BSDF value by propagating a value from an intermediate layer of the first machine learning-based model to the second machine learning-based model.

14. The method of claim 11, wherein the first partial BSDF value corresponds to a first range and the second partial BSDF value corresponds to a second range,
wherein the first range does not overlap the second range, and
wherein the second range is higher than the first range.

15. The method of claim 11, wherein the full BSDF value is determined by aggregating the first partial BSDF value and the second partial BSDF value.

16. The method of claim 11, further comprising:
sampling the ray direction based on a plurality of lobes corresponding to at least one of potential reflection and transmission at the 3D point.

17. The method of claim 16, wherein the sampling of the ray direction comprises estimating a spherical Gaussian (SG) parameter corresponding to each lobe from among the plurality of lobes, using a third machine learning-based model.

18. The method of claim 17, wherein the SG parameter comprises at least one of an axis, a sharpness, and an amplitude of a corresponding lobe.

19. The method of claim 16, wherein the sampling of the ray direction comprises:
determining a PDF corresponding to at least one of a reflection and a transmission of a ray at the 3D point based on a plurality of SG distributions in which the plurality of lobes is individually modeled; and
sampling the ray direction based on the determined PDF.

20. The method of claim 11, wherein the generating of the image corresponding to the scene comprises, based on determining that an object comprising a transparent material is included in the scene, generating a frame image corresponding to the scene within a threshold period of time by determining a corresponding pixel value using a BSDF value estimated based on a ray direction passing through the object.
